(19) United States
(12) Patent Application Publication
(10) Pub. No.: US 2004/0068426 A1
(43) Pub. Date: Apr. 8, 2004

(54) Shipment management system and method

(76) Inventor: ZeXiong Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,524

(22) Filed: Dec. 30, 2002

(30) Foreign Application Priority Data
Oct. 4, 2002 (TW) 91122979

(51) Int. Cl. G06F 17/60

(52) U.S. Cl. 705/8

(57) ABSTRACT

A shipment management system and method for shippers to conduct activities related to shipments is provided. The shipment management system comprises a shipper's management information system (10), and it comprises a vessel management module (100) for managing vessel ordering tasks, and for generating a bill of loading according to an ordering list; a loading spot management module (110) for managing loading spot tasks and informing shipping agent information system to provide containers and checking container bills; a document management module (120) for generating a provisional B/L and sending to shipping agent; a transportation management module (130) for searching for transportation information and managing transference case; and a payment management module (140) for managing invoices and payment related to the shipment.

### FIELD OF THE INVENTION

The present invention relates to shipment management systems and methods, and more particularly, to conducting and managing activities such as transference related to shipment via a computer system.

### BACKGROUND OF THE INVENTION

Shipment plays an important role in modem commercial goods logistics systems. The processes of ordering, loading, unloading and payment relating to shipment traditionally relies on paper-based documentation such as bills of ordering, bills of lading (B/L) and invoices. In the computer age, the shortcomings of traditional shipment management are stark. For example, manual compilation and checking of the documentation takes an unduly long time. This retards turnover and profitability of organizations such as shipping agents. In addition, it is difficult for a shipper to get timely information on a status of a shipment and a status of payment. The shipper must communicate with the shipping agent and the financial institution respectively to ascertain whether goods have arrived and whether payment has been made.

With widespread usage of the Internet, computerized shipment management systems overcome most of the above-described shortcomings of traditional shipment. The relevant technology is continually improving. U.S. Pat. No. 5,910,896 granted on Jun. 8, 1999 and entitled “Shipment Transaction System And An Arrangement Thereof” discloses a computer processing system for a shipment transaction involving a shipper and a shipping agent. The system is particularly suited to automating payment of a shipment transaction and providing access to relevant shipment information. The system includes a shipper processor, which receives purchase order information and assists in generating a B/L for the transaction. A shipper access terminal interfaces between the shipper processor and a central processor to control the quantity, quality, and timeliness of information transferred to the central processor. The central processor stores selective shipment information, and generates reports regarding the transactions. A carrier processor provides certification of delivery to the central processor. The central processor communicates with one or more financial institutions so that the shipper is billed and the carrier is paid for the relevant transaction.

Said computer processing system overcomes some shortcomings of traditional shipment. For example, a shipper can search for relevant information quickly and conveniently via the central processor, and can balance relevant fees easily by the transmitting electronic bills. However, with the development of modern commercial goods logistics, many shipments involve not only a shipper and shipping agent, but also a land transportation company, a container depot company and other companies as well. In addition, a shipper may require a change in transference during shipment. This may occur when the shipper's client wants to change a final destination for goods. Said computer processing system does not provide means to adequately deal with these matters. It is desired to provide a shipment management system and method that enables a shipper to manage shipment efficiently under almost any circumstances.

### SUMMARY OF THE INVENTION

An object of the present invention is to provide a shipment management system which enables a shipper to efficiently manage shipment and transference.

Another object of the present invention is to provide a shipment management method which enables a shipper to efficiently manage shipment and transference.

The present invention provides a shipment management system and method for use by a shipper, especially regarding transference. A preferred embodiment of the shipment management system comprises a shipper's management information system. The shipper's management information system is connected with a shipping agent information system, a distribution center information system, a container depot information system and a carrier information system via the Internet, for information exchange among any and all of said information systems. The shipper's management information system comprises: a vessel management module, which is used for the shipper to manage ordering of vessels and generation of bills of loading according to ordering lists; a loading spot management module, which is used for the shipper to manage shipment loading spots, to request a shipping agent information system to provide containers, and to check container bills sent by a shipping agent information system according to shipment information stored in the shipper's management information system; a document management module, which is used to generate provisional bills of lading, to send the provisional bills of lading to a shipping agent, to receive bills of lading from the shipping agent information system, and send the bills of lading to a buyer; a transportation management module, which is used to search for transportation information during shipment and to manage transference; and a payment management module, which is used to manage invoices and payment related to shipment.

A preferred embodiment of the shipment management method comprises the following steps: (a) a vessel management module receiving a shipment schedule and generating an ordering list accordingly; (b) the vessel management module generating a bill of loading according to the ordering list, and sending the bill of loading to a shipping agent information system; (c) the vessel management module receiving feedback information of the bill of loading from the shipping agent information system; (d) a document management module generating a provisional bill of lading (B/L) according to stored shipment documents, and sending the provisional B/L to the shipping agent information system; and (e) the shipping agent information system generating a B/L according to the provisional B/L, and sending the B/L to the loading spot management module, and the loading spot management module generating an invoice and a packing list, and sending the B/L, the invoice and the packing list to a buyer.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of a shipment management system in accordance with a preferred embodiment of the present invention;

FIG. 2 is an exemplary flowchart of ordering shipment in accordance with the present invention;

FIG. 3 is an exemplary flowchart of loading spot management in accordance with the present invention;

FIG. 4 is an exemplary flowchart of document management in accordance with the present invention; and

FIG. 5 is an exemplary flowchart of transference of goods in accordance with the present invention.

### DETAILED DESCRIPTION OF THE PREFERRED EMBODIMENT

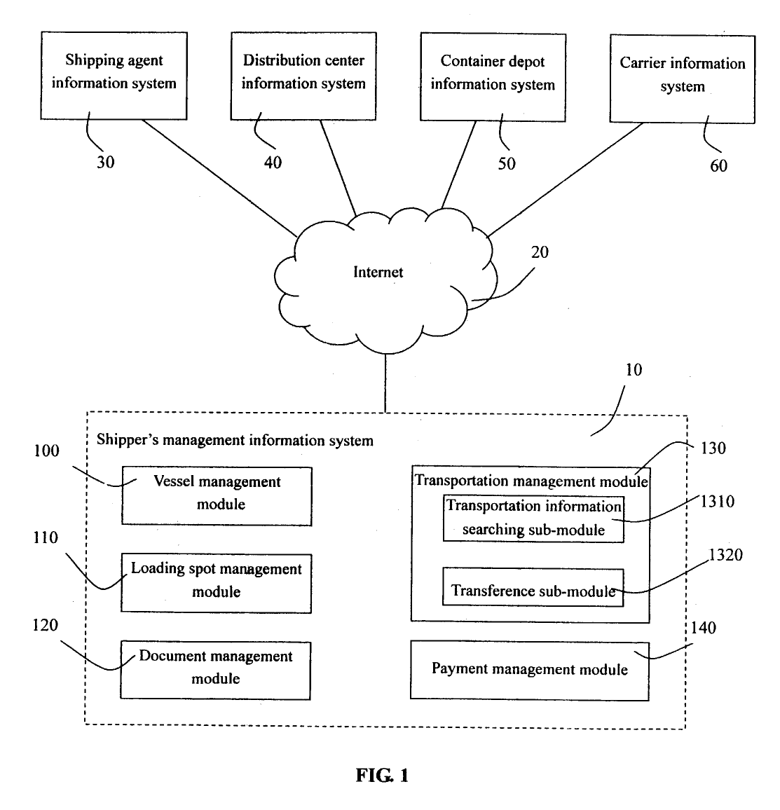

FIG. 1 is a block diagram of a shipment management system according to a preferred embodiment of the present invention. The shipment management system comprises a shipper's management information system 10. The shipper's management information system 10 is connected with a shipping agent information system 30, a distribution center information system 40, a container depot information system 50 and a carrier information system 60 via the Internet 20, for information exchange among any and all of said information systems. Following the development of modern logistics, most large manufacturing enterprises establish distribution centers in regions separate from their production facilities, for convenient distribution of their goods. In the preferred embodiment of the present invention, a shipping agent is defined as a sea transportation company, and a carrier is defined as a land transportation company. Carriers transport goods from production facilities to ports of loading for transportation by shipping agents.

The shipper's management information system 10 comprises a vessel management module 100, a loading spot management module 110, a document management module 120, a transportation management module 130, and a payment management module 140. The vessel management module 100 is used to manage shipment vessel orders. The vessel management module 100 generates an ordering list according to shipment information provided by a product branch of a manufacturing enterprise, generates a bill of loading according to the ordering list, and sends the bill of loading to the shipping agent information system 30 for checking. The loading spot management module 110 is used to manage shipment loading spots, after the loading spot management module 110 has checked relevant shipment information. The document management module 120 is used to generate and maintain relevant invoices, and send the invoices to buyers. The transportation management module 130 is used to search for transportation information related to shipments and to manage transference. The transportation management module 130 comprises a transportation information searching sub-module 1310 and a transference sub-module 1320. The transportation information searching sub-module 1310 is used for the shipper to manage shipment by instantly searching for transportation information related to shipment. The transference sub-module 1320 is used to evaluate the feasibility of transference, and to conduct transference. The payment management module 140 is used for the shipper to balance payments related to shipment.

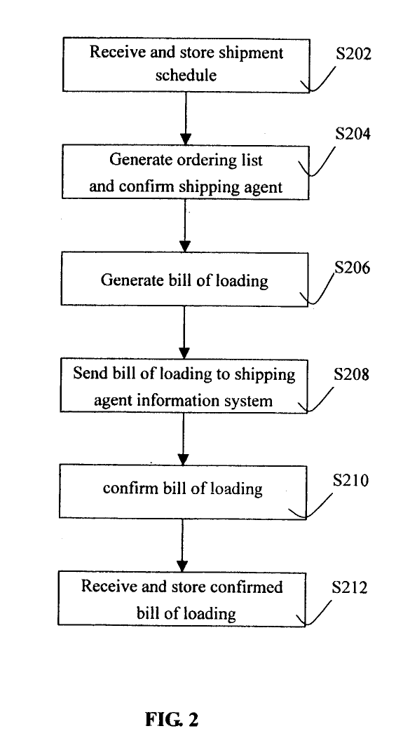

FIG. 2 is an exemplary flowchart of ordering shipment in accordance with the present invention. In step S202, the vessel management module 100 of the shipper's management information system 10 receives a shipment schedule provided by the product branch of a manufacturing enterprise, and stores the shipment schedule in the shipper's management information system 10. The product branch first draws up the shipment schedule during a production run at the production facilities, to arrange shipment systematically according to relevant current and future production runs and production schedules. In step S204, the vessel management module 100 generates an ordering list according to the shipment schedule, and confirms a shipping agent. The ordering list comprises fields including: item, group, customer, buyer, port of loading, port of discharge, final destination, closing date, net weight, gross weight, volume, forwarder, line, freight payable, and remark. In step S206, the vessel management module 100 generates a shipping order according to each item in the ordering list. If the ordering list contains a plurality of items having the same group, port of loading, port of discharge, final destination, customer, buyer, container type, carrier and line, the vessel management module 100 can combine the items and generate a gross volume in the corresponding bill of loading. In step S208, the vessel management module 100 sends the shipping order and bills of loading to the shipping agent information system 30. In the shipping order, some fields are blank, including: name of vessel, number of voyage, estimated time of departure (ETD), and estimated time of arrival (ETA). In step S210, the shipping agent information system 30 receives the shipping order and bills of loading, and confirms a berth, a number of the shipping order, the name of the vessel, the number of the voyage, the estimated time of departure and the estimated time of arrival. These details are confirmed according to actual prevailing operating conditions such as the capability of various shipping lines to perform the transportation. The shipping agent. information system 30 then sends the shipping order and bills of loading to the shipper's management information system 10. In step S212, the vessel management module 100 receives the shipping order and bills of loading and stores them in the shipper's management information system 10.

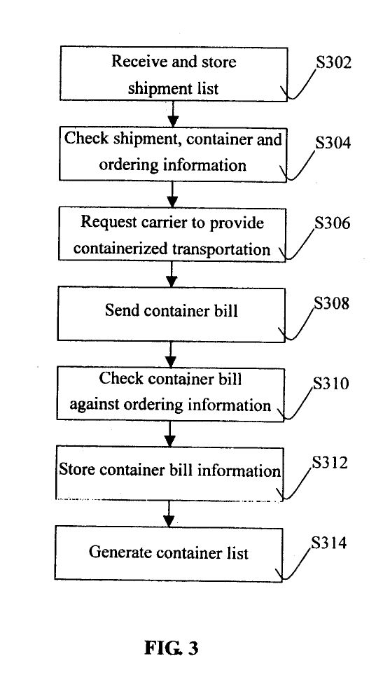

FIG. 3 is an exemplary flowchart of loading spot management in accordance with the present invention. In step S302, the loading spot management module 110 receives a shipment list provided by the product branch, and stores the shipment list in the shipper's management information system 10. The shipment list is drawn up by the product branch according to the shipment schedule. In step S304, goods are placed in a dispatch area of the production facilities ready for transportation. The loading spot management module 110 checks shipment information, container information and ordering information (including the ordering list and the shipping order), and confirms the correctness of said information. In step S306, the loading spot management module 10 sends a request and relevant information to the carrier information system 60 for the carrier to provide containerized transportation. In step S308, the carrier appoints a vehicle to the dispatch area, and sends a container bill to the shipper's management information system 10. To ensure security of shipment, the carrier can print out a hardcopy container bill for the driver of the vehicle to present at the dispatch area. In step S310, the loading spot management module 110 receives the container bill sent by the carrier information system 60, and checks the container bill against the ordering information to confirm the correctness thereof. In step S312, the loading spot management module 110 stores information in the container bill to the shipper's management information system 10. Such information includes: number of container, number of container bill, number of driver, number of vehicle, beginning time of loading, completion time of loading, and number of container seal. In step S314, the loading spot management module 110 generates a detailed container list according to the information recorded in step S312 after the goods have been taken away from the dispatch area by the vehicle.

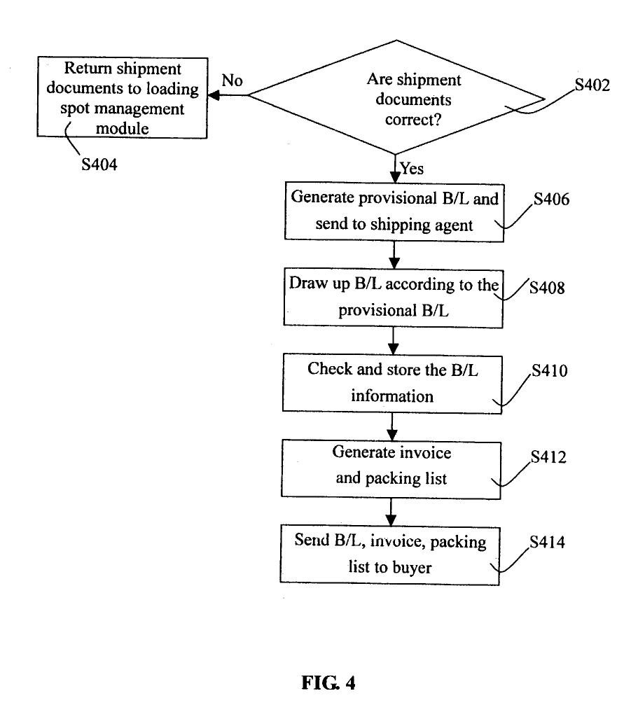

FIG. 4 is an exemplary flowchart of document management in accordance with the present invention. In step S402, the document management module 120 checks the shipment documents generated by the loading spot management module 110 and the shipment information stored in the shipper's management information system 10 to confirm whether the shipment documents are correct. The shipment documents checked include the shipment list, the container bill, and a loading list. The loading list is a detailed bill of information on goods loaded. If the shipment documents are not correct, in step S404, the document management module 120 returns them to the loading spot management module 110 for re-checking and amendment. If the shipment documents are correct, in step S406, the document management module 120 generates a provisional bill of lading (B/L) according to the relevant shipment information (such as the container bill and the loading list) stored in the shipper's management information system 10, and sends the provisional B/L to the shipping agent information system 30. In step S408, the shipping agent draws up a B/L according to the provisional B/L, and sends the B/L to the shipper's management information system 10. In step S410, the shipper's management information system 10 checks the contents of the B/L against the information stored in the shipper's management information system 110 itself, to ensure the correctness of the B/L. In step S412, the document management module 120 generates an invoice and a packing list according to the contents of the B/L. In step S414, the shipper's management information system 10 sends the B/L, the invoice, the packing list and other relevant information to the buyer, so that the buyer can monitor related activities thereafter.

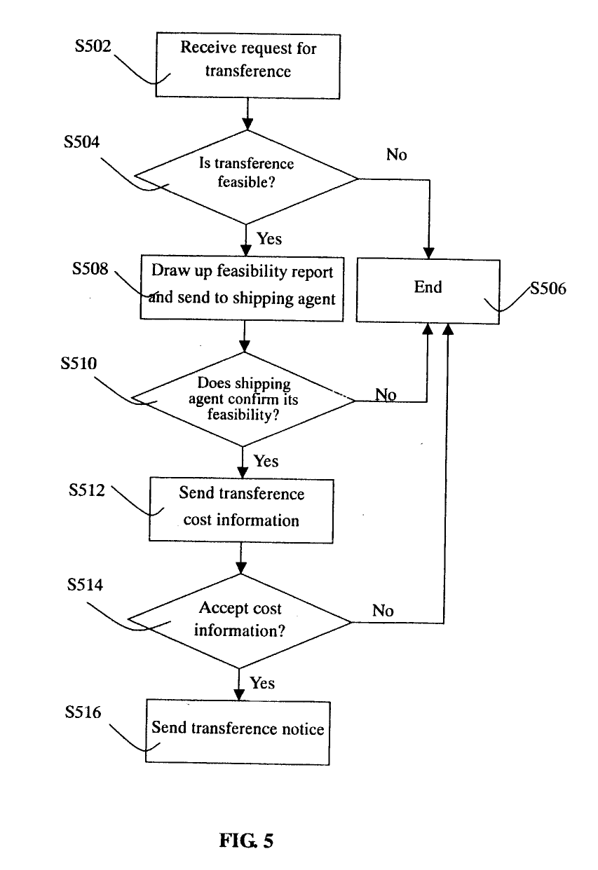

FIG. 5 is an exemplary flowchart of transference of goods in accordance with the present invention. In step S502, a shipper receives a request for transference of goods. In step S504, the shipper evaluates the feasibility of the transference. For example, the cost and timing of the transference is evaluated. If the transference is not feasible, the procedure is ended. If the transference is feasible, in step S508, the transference sub-module 1320 draws up a feasibility report and sends the report to the shipping agent information system 30. In step S510, the shipping agent evaluates the feasibility report according to actual prevailing operating conditions such as the capability of various shipping lines to perform the necessary transportation. The shipping agent thus determines whether the transference is feasible. If the transference is not feasible, the procedure is ended. If the transference is feasible, in step S512, the shipping agent sends relevant transference cost information to the shipper's management information system 10. In step S514, the transference sub-module 1320 evaluates the transference cost information, and determines whether to accept the transference cost information. If the transference cost information is not accepted, the procedure is ended. If transference cost information is accepted, in step S516, the transference sub-module 1320 sends a transference notice to the shipping agent for transference of the goods.

The shipper can use the transportation information searching sub-module 1310 to search the shipping agent information system 30 for transportation information, to search the container depot information system 50 for reports on inbound and outbound movement of goods, and to search the distribution center information system 40 for real-time stock information.

After delivery of the goods to the buyer, the payment management module 140 of the shipper's management information system 10 receives relevant invoices from the shipping agent information system 30 and from the carrier information system 60. The shipper's management information system 10 processes transference payments according to the contents of the invoices.

In general, the shipment management system and method of the present invention may take forms other than what is described above. While the preferred embodiment for carrying out the invention has been described in detail, those familiar with the art to which the invention relates will recognize various alternative designs and embodiments for practicing the invention. These alternative embodiments are also within the scope of the present invention. The scope of the present invention is defined by the claims appended hereto and allowable equivalents thereof.

What is claimed is:

1. A system for shipment management, the system comprising:
a vessel management module, for managing vessel ordering tasks related to shipment, and for generating a bill of loading according to an ordering list;
a loading spot management module, for managing loading spot tasks, sending container information to a shipping agent, and checking container bills sent by a shipping agent;
a document management module, for generating provisional bills of lading and sending provisional bills of lading to a shipping agent;
a transportation management module, for searching for transportation information related to shipment and for managing transference; and
a payment management module, for managing invoices and payment related to shipment.

2. The shipment management system as described in claim 1, wherein the transportation management module comprises a transportation information searching sub-module, for searching a shipping agent information system for transportation information, for searching a container depot information system for information on inbound and outbound movement of goods, and for searching a distribution center information system for stock information.

3. The shipment management system as described in claim 1, wherein the transportation management module comprises a transference sub-module, for managing transference.

4. The shipment management system as described in claim 1, wherein the shipping agent has a shipping agent information system, and the shipping agent information system is connected with a container depot information system to search for information on inbound and outbound movement of goods.

5. The shipment management system as described in claim 1, wherein the shipping agent shipping agent has a shipping agent information system, and the shipping agent information system is connected with a distribution center information system to search for stock information.

6. The shipment management system as described in claim 1, wherein the vessel management module generates ordering lists according to shipment schedules.

7. The shipment management system as described in claim 1, wherein the loading spot management module generates a container list.

8. The shipment management system as described in claim 1, wherein the document management module generates invoices according to bill of lading.

9. A shipment management method, comprising the following steps:
(a) receiving a shipment schedule, and generating an ordering list accordingly;
(b) generating a bill of loading according to the ordering list, and sending the bill of loading to a shipping agent;
(c) receiving feedback information from the shipping agent;
(d) generating a provisional bill of lading according to stored shipment documents, and sending the provisional bill of lading to the shipping agent; and
(e) receiving a bill of lading sent by the shipping agent, generating an invoice, and sending the bill of lading and the invoice to a buyer.

10. The shipment management method as described in claim 9, further comprising the step of:
sending a container notice to a carrier, and checking a container bill sent by the carrier.

11. The shipment management method as described in claim 9, further comprising confirming the step of:
informing the shipping agent of any transference needed.

12. The shipment management method as described in claim 11, further comprising the step of:
evaluating feasibility of the transference.

13. The shipment management method as described in claim 9, further comprising the step of:
balancing payment related to shipment.

14. The shipment management method as described in claim 13, wherein
the step of balancing payment is performed based on the invoice.

15. A method of managing shipment for a shipper, comprising steps of:
providing data communication among the shipper, a by-ground carrier and a by-sea shipping agent;
receiving a shipment schedule and generating an ordering list accordingly;
generating a bill of loading according to the ordering list and sending said bill of loading to the shipping agent;
generating a provisional bill of lading accordingly and send said provisional bill of lading to the shipping agent, if the shipping agent sends a positive feedback, with regard to the bill of loading, to the shipper; and
informing the carrier of sending vehicles to a loading spot for loading goods; wherein
the shipping agent evaluates feasibility of transference and provides the shipper with information regarding corresponding transference fees, if necessary.
